(19) United States
(12) Patent Application Publication
(10) Pub. No.: US 2018/0196814 A1
(43) Pub. Date: Jul. 12, 2018

(54) QUALITATIVE AND QUANTITATIVE ANALYSIS OF DATA ARTIFACTS USING A COGNITIVE APPROACH

(71) Applicant: International Business Machines Corporation, Armonk, NY (US)

(72) Inventors: Peter B. Ferguson, Dublin, OH (US); Rahul Jain, Bangalore (IN); Erik P. Schilling, Dublin, OH (US); Krishma Singla, Bangalore (IN); Manjit S. Sodhi, Bangalore (IN); Michael Yesudas, Plano, TX (US)

(21) Appl. No.: 15/404,350

(22) Filed: Jan. 12, 2017

(51) Int. Cl. G06F 17/30; G06N 99/00

(52) U.S. Cl. CPC G06F 17/3053; G06F 17/30241; G06F 17/30598; G06N 99/005

(57) ABSTRACT

An artifact processing system and method for ranking artifacts is provided. The method includes the steps of creating an artifact repository, analyzing the plurality of artifacts based on a plurality of parameters, and assigning a weighted value to each parameter of the plurality of parameters based on a business requirement, a user requirement, and a technical specification to determine a quantitative score of each artifact, determining a qualitative score of each artifact of the plurality of artifacts by filtering the plurality of artifacts, and calculating a total weighted value of each artifact of the plurality of artifacts, clustering the plurality of artifacts from the plurality of data buckets during a search of the artifact repository using the qualitative value of each artifact to provide a closest match based on the user selected parameters, retrieving a cluster containing the closest match and ranking the artifacts within the cluster based on the qualitative score of the artifacts within the cluster.

### BACKGROUND

The present invention relates to systems and methods of an artifact processing system, and more specifically to embodiments of an artifact processing system and method that ranks artifacts for map file creation.

One of the problems faced during map file creation in EDI (Electronic Data Interchange) is that the user has to deal with heterogeneous sets of data formats across standards and versions. These incompatibilities between formats can be managed manually by a human expert who takes informed decisions on the mapping rules and steps to be taken to overcome the semantic and structural dissimilarities between elements. The human expert also tries to find the best possible existing artifacts that can be re-used in order to minimize the turnaround time for the current map file creation. Moreover, the decisions taken on best possible match and the order of ranking of the set of closest matched artifacts is subjective—affected by the experience and skill level of the human expert. Scaling these experts in a cost-effective fashion is a considerable challenge.

### SUMMARY

An embodiment of the present invention relates to a method, and associated computer system and computer program product, for ranking artifacts. A processor of a computing system creates an artifact repository, the artifact repository including a plurality of artifacts. The plurality of artifacts are analyzed based on a plurality of parameters, and assigned a weighted value based on a business requirement to determine a quantitative score of each artifact. A qualitative score of each artifact of the plurality of artifacts is determined by filtering the plurality of artifacts into one or more parameters, and a total weighted value is calculated for each artifact of the plurality of artifacts, wherein the plurality of artifacts are separated into a plurality of data buckets based on user selected parameters. The plurality of artifacts are clustered from the plurality of data buckets during a search of the artifact repository using the qualitative value of each artifact to provide a closest match based on the user selected parameters. The cluster containing the closest match is retrieved, and the artifacts within the cluster are ranked based on the qualitative score of the artifacts within the cluster. The ranked artifacts are provided to the user.

### BRIEF DESCRIPTION OF THE DRAWINGS

FIG. 1 depicts a block diagram of an artifact processing system, in accordance with embodiments of the present invention.

FIG. 2 depicts a flow chart of a method for ranking artifacts, in accordance with embodiments of the present invention.

FIG. 3 depicts a flow chart of a step of the method of FIG. 2 for clustering artifacts from the data buckets, in accordance with embodiments of the present invention.

FIG. 4 illustrates a block diagram of a computer system for the artifact processing system of FIG. 1, capable of implementing methods for ranking artifacts of FIG. 2, in accordance with embodiments of the present invention.

### DETAILED DESCRIPTION

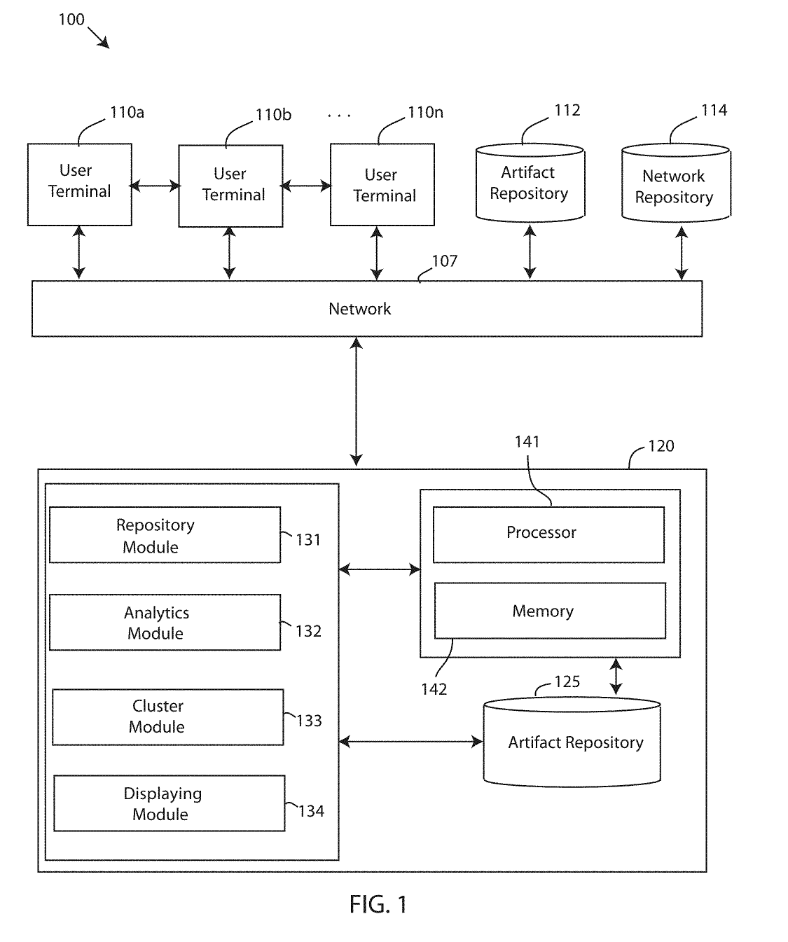

Referring to the drawings, FIG. 1 depicts a block diagram of an artifact processing system 100, in accordance with embodiments of the present invention. Embodiments of an artifact processing system 100 may be used as a capability to adopt a cognitive approach to rank Electronic Data Interchange (EDI) files that are suitable to the needs of a user, such as a human expert. It is done so by providing a detailed description of the execution steps that would create a cognitive system to achieve this automation. The artifact processing system 100 may include a series of implementation steps which would not only describe the process based steps to filter out extraneous elements but also use a cognitive approach to traverse the last mile before the best possible matches can be ranked out in a way that is suitable to the needs of the user human expert. The artifact processing system 100 may be automated by a cognitive system. The system 100 may provide recommendations in terms of an approach that can be taken by the user to accomplish the job, and reduce a turnaround time.

Moreover, embodiments of the artifact processing system 100 may use a weight based quantitative analysis of artifacts, such as documents associated with EDI files. As part of system 100, a first set of generic filters may be created and/or defined based on a generic business requirements, the filter may be divided into none or more criteria, and weights may be assigned to each criterion, based on a user requirement. Then, a set of business and domain specific filters may be created, wherein each filter may be split into a combination of one or more generic criteria for qualitative analysis of the artifacts. For instance, the qualitative value of the EDI file may be a summation of the quantitative values of each filter or artifact that has been filtered. Data points may be retrieved using the quantitative analysis of the artifacts, and then a cognitive approach of unsupervised learning involving a data clustering algorithm may be used. The cluster with the closest possible match, resulting from a step of clustering the artifacts, may be retrieved. Individual artifacts contained within the retrieved cluster may be ranked. Clustering may be a result of a process of “bucketing” performed prior to the clustering, wherein the artifacts in an artifact repository are separated into buckets based on a plurality of parameters or general criteria. The parameters and/or a priority for bucketing the artifacts may be user configurable, and may depend on a type of input provided in a custom graphical user interface (GUI).

Embodiments of the artifact processing system 100 may further utilize user feedback to re-train the system 100. User feedback received post-search results may further refine the search result for successive users. This can be done with the help of the same custom GUI where the user can assign extra points to an artifact ranked n and move the artifact to rank n−1. The extra points can be calculated based on numerous factors including but not limited to the quantitative weight difference between artifacts, the number of times the rank of the artifact has been changed in the past to better or worse.

Implementation of the artifact processing system 100 may be valuable to a map file developer wanting to transform EDI files from one format to another. System 100 may help the user to query the artifact repository in a more structured way because the custom GUI would display all the available options as per the business requirements of an organization. Further, the weight based quantitative approach to evaluate the EDI files is user configurable and thus each organization can configure the parameters as per their business requirements. The implementation of an unsupervised learning using a data clustering algorithm may further obviate a need for regular training of the system. For instance, the user would only have to keep adding the data points for quantitative analysis and the clustering algorithm would take care of publishing the closest match. This approach may reduce a dependency on the prior skill/experience of the developer querying the artifact database and developing the map file. Additionally, embodiments of system 100 may help a developer to reduce the turn-around time for map file creation, gap analysis, and finding prior implementations, resulting in faster completion of requirement gathering and creation of implementation guidelines for custom application layouts by giving more reliable data to the developer to start with. Embodiments of system 100 may also refine results over time based on repeated usage by the group and their feedback.

Referring still to FIG. 1, embodiments of the artifact processing system 100 include a preprocessing stage and a search stage. Embodiments of the preprocessing stage may be a process that can be executed as a pre-processor so that a plurality of data buckets that are generated may be available for further processing based on an outcome of another set of processes during the search stage. For instance, a repository of artifacts may be created. The artifact repository may include all the created or existing work items including but not limited to a map file, test files, requirement specification documents, reports, and implementation guidelines. The artifact repository may then be processed via a batch program wherein the work items are divided into hierarchical buckets of data based on programmed criteria including but not limited to customer name, domain, and application layout type. These criteria may be applied in an order of priority. For example: the highest priority can be given to the preferences entered by the user via the custom graphical user interface (GUI) created to cooperate with the artifact processing system 100. A sequence could be one of the order of priorities (filters) for programmatically segregating the repository data into user defined buckets. In one embodiment, a first filter may be applied, wherein the first filter segregates the work packets of the artifact repository based on those parameters that are defined in GUI, such as transaction name, version, flow (inbound/outbound), kind of application layout, customer, domain etc. In an exemplary embodiment, a first filter and a second filter may be applied, wherein the second filter evaluates each test file within the work packet and may perform an intra-work packet ranking of the files so that every work packet corresponding to each map file has only one set of test files (input/output) that would eventually be part of an overall comparison. This is done by comparing each test file within the work packet with the common sample of an EDI file which has all the segments and each segment has all the data. This step may assign a quantitative score to the best matched test file in each work packet of the repository. This score may be one of the parameters for programmatically clustering the work items of the repository during the search stage. These exemplary filtering steps may be embodied in the following:

TABLE 1

| Criteria | | | |
|---|---|---|---|
| Identifier | Criteria | Weight | Comments |
| Cl | Header | 2 | To tell whether a particular piece of information is in header |
| C2 | Detail | 3 | To tell whether a particular piece of information is in detail |
| C3 | Summary | 1 | To tell whether a particular piece of information is in summary |
| C4 | General | 3 | General criteria is valid for the overall message |
| C5 | Optional | 1 | To tell whether a particular piece of information is in optional |
| C6 | Mandatory | 2 | To tell whether a particular piece of information is in mandatory |
| C7 | Conditional | 3 | To tell whether a particular piece of information is in conditional |
| C8 | Business Value | 3 | To indicate the business value of that piece of data |
| C9 | Segment | 3 | To indicate that we are just looking for the presence of that segment in the message |
| C10 | Qualifier | 2 | To indicate that we are looking for the presence of some qualifier |
| C11 | Data | 1 | To indicate that we are looking for the presence of some data in the segment |

TABLE 2

| | Business | | | Total | |
|---|---|---|---|---|---|
| Filters | Significance | Level | Criteria | Weight | Additional Comments |
| R1 | See section 1 | Header | C1 + C6 + C10 | 6 | |
| R2 | See section 1 | Header | C1 + C6 + C10 | 6 | |
| R3 | See section 1 | Header | C1 + C6 + C9 | 7 | |
| R4 | See section 1 | Header | C1 + C5 + C8 + C9 | 9 | |
| R5 | See section 1 | Header | C1 + C5 + C9 | 6 | |
| R6 | See section 1 | Header | C1 + C5 + C9 | 6 | |
| R7 | See section 1 | Header | C1 + C6 + C8 + C9 + C10 | 12 | Needs to be calculated for all- |
| | | | | | BT, ST and SE |
| R8 | See section 1 | Header | C1 + C7 + C8 + C9 | 11 | For N3 and N4. No need to |
| | | | | | calculate for N2. |
| R9 | See section 1 | Detail | C2 + C6 + C8 + C9- | 11 | Message level means the weight |
| | | | message level | 9 | for the occurrence of this |
| | | | C7 + C8 + C11- | | segment |
| | | | segment level | | Segment level means the weight |
| | | | | | for the occurrence of data |
| | | | | | within that segment |
| R10 | See section 1 | Detail | C2 + C5 + C9 | 7 | |
| R11 | See section 1 | Detail | C2 + C5 + C9 | 7 | |
| R12 | See section 1 | Detail | C2 + C5 + C9 | 7 | |
| R13 | See section 1 | Detail | C2 + C5 + C8 + C9 | 10 | |
| R14 | See section 1 | Detail | C2 + C5 + C9 | 7 | |
| R15 | See section 1 | Detail | C2 + C5 + C9 | 7 | |
| R16 | See section 1 | Summary | C3 + C6 + C9 | 6 | |
| R17 | See section 1 | Summary | C3 + C5 + C9 | 5 | |
| R18 | See section 1 | General | C4 + C6 + C8 | 8 | |

The total weight of the EDI document can be found out by summing of the weights of all the filters of the corresponding data present. The document with the highest value will be the top-ranked artifact in the search results. Table 1 and Table 2 depict a process of assigning weights to specific piece of data in an EDI file; however, the process depicted by Table 1 and Table 2 is only an illustration and can be changed accordingly after discussion with a domain expert and/or EDI consultant.

Embodiments of the preprocessor stage may modify the artifact repository so that an intelligent search for similar artifacts can be done on existing artifacts. For instance, appropriate buckets based on certain defining and differentiating parameters such as customer name, application layout etc. may be created. The above-described filtering may generally be based on heuristics which have been conceptualized over the years by experts and tested for accuracy over the experts' experience. Embodiments of filters may be explicit in nature as the filters are provided through parameters filled by the users through an interface. The plurality of data buckets may be essential to bring down the scope of cognitive logic which is used in the second part of the process as it filters out the outliers and hence increase the probability of getting accurate numbers.

Furthermore, embodiments of the artifact processing system 100 may include a search stage. During the search stage, the user may enter one or more preferences via a custom GUI built for capturing user inputs regarding a sample customer test file, customer name, domain, direction of flow, EDI standard, version etc. The user provided sample customer test file may be evaluated against a valid EDI file of a same transaction and version. This file may have all of the segments, and each segment has all of the data for that transaction as per standards. A quantitative weight of the file may then be calculated, similar to the one outlined above in the preprocessing stage. Other user inputs may be used to pick up a correct set of data buckets generated in the preprocessing stage, wherein a number of buckets that need to be analyzed may be brought down to those sets which pertain to the customer name, domain, direction of flow, EDI standard etc. provided by the user. In a final step, a cognitive approach of unsupervised learning using a clustering algorithm may be implemented. In this step, the test files shortlisted in the preprocessed are clustered based on a plurality of parameters, and each segment of the user provided test file is taken and test files in the artifact repository are segregated in clusters using a clustering algorithm and the data points for that segment. The process may be iterated for all of the segments of the user test file until a final set of clusters is obtained which has the test file segregated based on all the above steps. A first cluster in this sequence may have the test files which are closest match to the user provided inputs. The results may be displayed on the same custom GUI and ranked based on a combination of parameters of the data points. The user can then locate the map files for these test files and re-use those map files to reduce the development time.

After reviewing the ranked search results, the user has the option to “tweak” the rankings to incorporate the user's understanding of the domain, business and/or EDI requirements. The user can move the artifact to any rank but the extra points added/subtracted to/from the quantitative weight of the file can be based on multiple factors including but not limited to a difference in quantitative weights between the file being moved and the file being replaced, a number of times it has happened in the past that the users have given a similar feedback, etc. Thus, the system may be re-trained with the additional knowledge that comes in from the expert users with feedback and helps the system to become smarter. The above-described embodiment is illustrated using a scenario wherein the GUI user inputs a test file and follows the set of processes described above to find the matching test file which then helps in tracing the map file. The process can also be programmatically altered to directly provide the matching map files to the end user. The process resulting from embodiments of the artifact processing system 100 may also be used to find the matching layouts, implementation guidelines and any other artifact that is part of the artifact repository and related directly or indirectly to the user provided test file.

Accordingly, the search stage may be two-fold. For example, one aspect may extract parametric information which can be used to align an incoming artifact to a specific data bucket (as discovered from pre-processing stage). This may ensure that elementary filters are applied while performing a similarity recommendation process for any incoming artifact. Now, with the identified category of existing artifacts, a cognitive approach may be used to further eliminate the odds. Embodiments of a cognitive approach may include the following steps. An incoming artifact may be compared to a super set of the identified layout/transaction/version to identify and list the differences. Using document similarity techniques, the closest matches may be determined based on the identified criteria (the most impacting features may be picked up). According to the weight given to each criterion, the possible matches can be ranked. Based on a threshold value (which can be configured externally) the system 100 may decide if any given match recommendation should be suggested to the user for a probable match. The user can then decide on taking an action by accepting or rejecting the recommendation, and may also decide to provide feedback to the system to fine tune the approach.

With continued reference to FIG. 1, embodiments of the artifact processing system 100 may include one or more user terminals 110a, 110b, . . . 110n (referred to collectively as “user terminal 110”) communicatively coupled to a computing system 120 via an I/O interface and/or over a network 107. For instance, some or all of the user terminals 110 may be connected via an I/O interface to computer system 120. The number of user terminals 110 connecting to computer system 120 via data bus lines and/or over network 107 may vary from embodiment to embodiment, depending on the number of users querying the artifact repository 112 or 125. The reference numbers with sub-letters and/or ellipses, for example describing user terminals as 110a, 110b, . . . 110n, may signify that the embodiments are not limited only to the amount of elements actually shown in the drawings, but rather, the ellipses between the letters and the n^{th} element indicate a variable number of similar elements of a similar type. For instance, with regard to the user terminals 110 depicted in FIG. 1, any number of a plurality of user terminals 110 may be present including user terminal 110a, user terminal 110b, and a plurality of additional user terminals up to the n^{th} number of user terminals 110n, wherein the variable “n” may represent the last element in a sequence of similar elements shown in the drawing. Embodiments of the user terminal may be a user computer or any computing device capable of connecting to the computing system 120 of the artifact processing system 100.

Some or all of the user terminals 110 may transmit data by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, and user terminals 110, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user preferences, search queries, business requirements, and the like, to generate both historical and predictive reports. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Embodiments of the computing system 120 may include a repository module 131, an analytics module 132, a cluster module 133, and a displaying module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the repository module 131 may include one or more components of hardware and/or software program code for establishing, creating, and/or maintaining an artifact database, such as a local artifact repository 125 or remote artifact repository 112. The artifact repository 124, 112 may be preprocessed so that a plurality of data buckets are created based on a plurality of criteria and user-selectable parameters.

With continued reference to FIG. 1, embodiments of the computing system 120 of the artifact processing system 100 may include an analytics module 132. Embodiments of the analytics module 132 may include one or more components of hardware and/or software program code for analyzing the artifacts of the artifacts repository 112, 125 based on a plurality of parameters, and assigning a weighted value to each parameter of the plurality of parameters based on a business requirement a user requirement, and a technical specification to determine a quantitative score of each artifact. Embodiments of the analytics module 132 may also include one or more components of hardware and/or software program code for determining a qualitative score of each artifact of the plurality of artifacts by filtering the plurality of artifacts into one or more parameters, and calculating a total weighted value of each artifact of the plurality of artifacts, wherein the plurality of artifacts are separated into a plurality of data buckets based on user selected parameters.

Embodiments of the analytics module 132 may build an EDI transaction of particular combination of standard and version, and ensure that the transaction is EDI compliant and has all of the segments, and for each segment, ensure that the segment has all of the data. Then, the analytics module 132 may define a generic set of filters, wherein the filters may be decided based on a generic business requirement, for example. Embodiments of the analytics module 132 may also build a generic set of criteria that may depend on a structure of an EDI message. The generic criteria may be common across all of the transactions of a particular standard and some of these might be reused across multiple standards if there is a similarity in syntax and semantics. Then, the analytics module 132 may assign weights to each criterion, wherein a higher weight signifies a greater importance. The weight may be assigned based on a user requirement, for example. Further, embodiments of the analytics module 132 may determine whether analysis is needed for a particular domain. If yes, then the analytics module 132 may define domain related filters, wherein the domain related filters may be in addition to the generic business filters. If not, then the analytics module 132 may compute a weight of a filter by breaking the filter into the filter's constituent criteria and summing the weights of all. The summation may become the weight of that particular criterion. The analytics module 132 may then compute the sum of all of the filters to find a total weight of the document, wherein the document with the higher total weight may be ranked higher.

Embodiments of the computing system 120 of the artifact processing system 100 may include a cluster module 133. Embodiments of the cluster module 133 may include one or more components of hardware and/or software program code for clustering the plurality of artifacts from the plurality of data buckets during a search of the artifact repository using the qualitative value of each artifact to provide a closest match based on the user selected parameters. Embodiments of the clustering module 133 may include one or more components of hardware and/or software program code for retrieving a cluster containing the closest match and ranking the artifacts within the cluster based on the qualitative score of the artifacts within the cluster.

With continued reference to FIG. 1, embodiments of the computing system 120 of the artifact processing system 100 may include a displaying module 134. Embodiments of the displaying module 134 may include one or more components of hardware and/or software program code for displaying or otherwise providing the ranked artifacts to the user.

Embodiments of the computing system 120 may be equipped with a memory device 142 which may store the various user information, data, artifact ranks, artifact scores, queries, and the like, and a processor 141 for implementing the tasks associated with the artifact processing system 100.

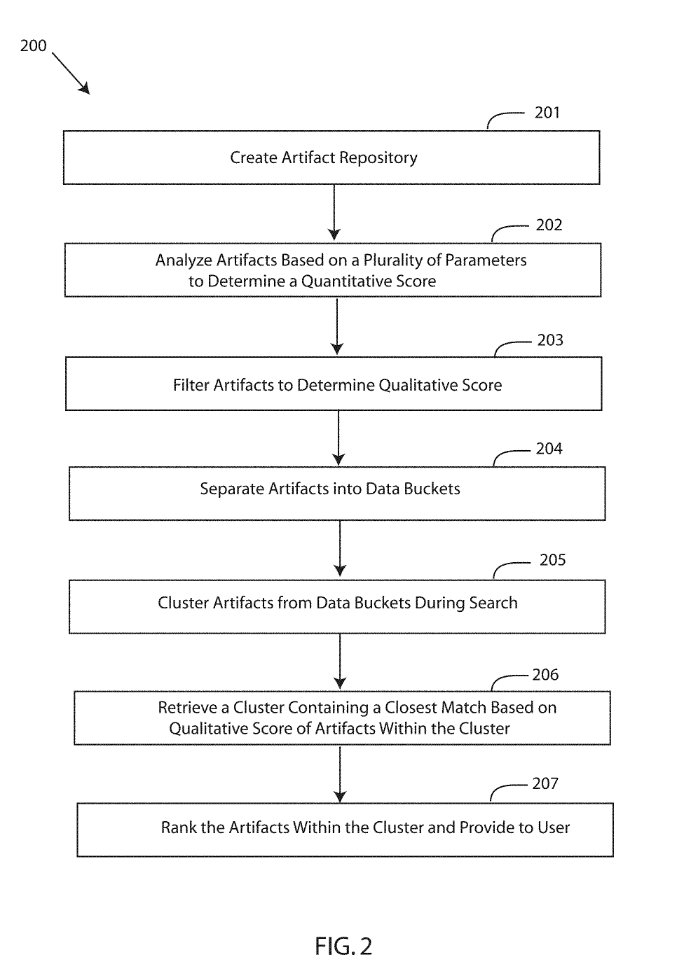

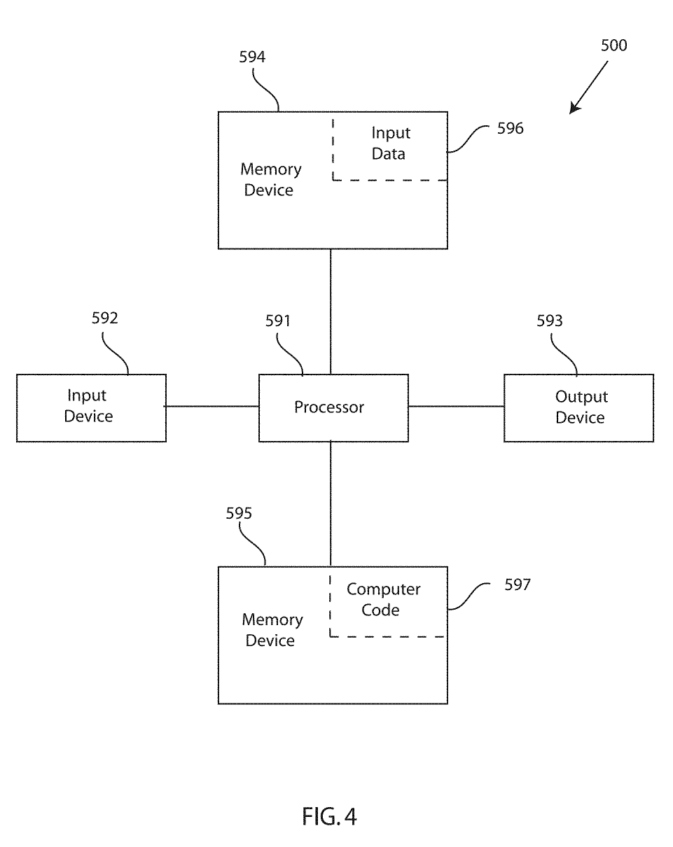

Referring now to FIG. 2, which depicts a flow chart of a method 200 for ranking artifacts, in accordance with embodiments of the present invention. One embodiment of a method 200 or algorithm that may be implemented for ranking artifacts in accordance with the artifact processing system 100 described in FIG. 1 using one or more computer systems as defined generically in FIG. 4 below, and more specifically by the specific embodiments of FIG. 1.

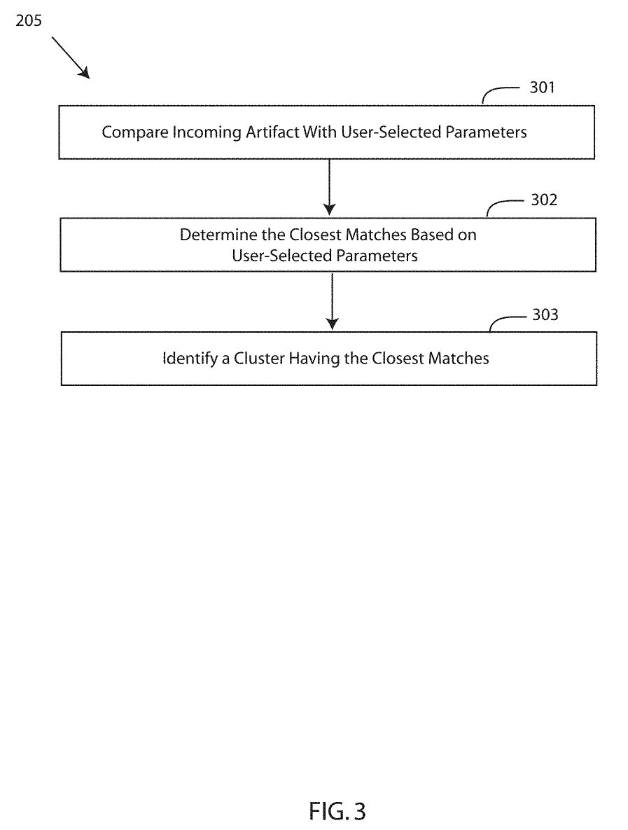

Embodiments of the method 200 for ranking artifacts may begin at step 201 wherein an artifact repository is created. Step 202 analyzes the artifacts stored on the artifact repository based on a plurality of parameters to determine a quantitative score of the artifact. Step 203 filters the artifacts to determine a qualitative score of the artifacts. Step 204 separates the filtered artifacts in a plurality of hierarchal data buckets. Step 205 clusters the artifacts containing a closest match based on the qualitative score of artifacts within the cluster. FIG. 3 depicts a flow chart of a step of the method of FIG. 2 for clustering artifacts from the data buckets, in accordance with embodiments of the present invention. Step 301 compares the incoming artifact with the user-selected parameters. Step 302 determines the closest matches based on the user-selected parameters. Step 303 identifies a cluster having the closest matches.

Referring back to FIG. 2, step 206 retrieves the cluster containing the closest match(es) based on the qualitative score of the artifacts within the cluster. Step 207 then ranks the artifacts within the retrieved cluster to provide to the user. This may be helpful for a map file creation.

FIG. 4 illustrates a block diagram of a computer system 500 that may be included in the system of FIGS. 1-2 and for implementing the methods of FIGS. 2-3 in accordance with the embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for ranking artifacts, in the manner prescribed by the embodiments of FIGS. 2-3 using the artifact processing system of FIG. 1, wherein the instructions of the computer code 597 may be executed by processor 591 via memory device 595. The computer code 597 may include software or program instructions that may implement one or more algorithms for implementing the methods for ranking artifacts, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 4.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or artifact repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to artifact processing systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to rank or otherwise process artifacts in an artifact repository. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for ranking artifacts. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for ranking artifacts.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method of ranking artifacts for map file creation, comprising:
creating, by a processor of a computing system, an artifact repository, the artifact repository including a plurality of artifacts;
analyzing, by the processor, the plurality of artifacts based on a plurality of parameters, and assigning a weighted value to each parameter of the plurality of parameters based on a business requirement, a user requirement, and a technical specification to determine a quantitative score of each artifact;
determining, by the processor, a qualitative score of each artifact of the plurality of artifacts by filtering the plurality of artifacts based on one or more parameters, and calculating a total weighted value of each artifact of the plurality of artifacts, wherein the plurality of artifacts are separated into a plurality of data buckets based on user selected parameters;
clustering, by the processor, the plurality of artifacts from the plurality of data buckets during a search of the artifact repository using the qualitative value of each artifact to provide a closest match based on the user selected parameters;
retrieving, by the processor, a cluster containing the closest match and ranking the artifacts within the cluster based on the qualitative score of the artifacts within the cluster; and
providing, by the processor, the ranked artifacts to the user.

2. The method of claim 1, further comprising receiving, by the processor, user feedback to refine the ranked artifacts, wherein the user assigns extra points to an artifact to increase a rank of the artifact.

3. The method of claim 2, wherein the user feedback is used to provide refined search results for successive users.

4. The method of claim 1, wherein the plurality of parameters include generic criteria such as transaction name, version, inbound or outbound, kind of application, EDI standard, layout, customer, domain, section.

5. The method of claim 1, wherein the plurality of artifacts are EDI documents.

6. The method of claim 1, wherein clustering includes comparing an incoming artifact with the user-selected parameters.

7. The method of claim 1, wherein clustering is a cognitive approach of unsupervised learning wherein a data cluster algorithm is used.

8. A computer system, comprising:
a processor;
a memory device coupled to the processor; and
a computer readable storage device coupled to the processor, wherein the storage device contains program code executable by the processor via the memory device to implement a method for rankings artifacts, the method comprising:
creating, by a processor of a computing system, an artifact repository, the artifact repository including a plurality of artifacts;
analyzing, by the processor, the plurality of artifacts based on a plurality of parameters, and assigning a weighted value to each parameter of the plurality of parameters based on a business requirement, a user requirement, and a technical specification to determine a quantitative score of each artifact;
determining, by the processor, a qualitative score of each artifact of the plurality of artifacts by filtering the plurality of artifacts into one or more parameters, and calculating a total weighted value of each artifact of the plurality of artifacts, wherein the plurality of artifacts are separated into a plurality of data buckets based on user selected parameters;
clustering, by the processor, the plurality of artifacts from the plurality of data buckets during a search of the artifact repository using the qualitative value of each artifact to provide a closest match based on the user selected parameters;
retrieving, by the processor, a cluster containing the closest match and ranking the artifacts within the cluster based on the qualitative score of the artifacts within the cluster; and
providing, by the processor, the ranked artifacts to the user.

9. The computer system of claim 8, further comprising receiving, by the processor, user feedback to refine the ranked artifacts, wherein the user assigns extra points to an artifact to increase a rank of the artifact.

10. The computer system of claim 9, wherein the user feedback is used to provide refined search results for successive users.

11. The computer system of claim 8, wherein the plurality of parameters include generic criteria such as transaction name, version, inbound or outbound, kind of application, EDI standard, layout, customer, domain, section.

12. The computer system of claim 8, wherein the plurality of artifacts are EDI documents.

13. The computer system of claim 8, wherein clustering includes comparing an incoming artifact with the user-selected parameters.

14. The computer system of claim 8, wherein clustering is a cognitive approach of unsupervised learning wherein a data cluster algorithm is used.

15. A computer program product, comprising a computer readable hardware storage device storing a computer readable program code, the computer readable program code comprising an algorithm that when executed by a computer processor of a computing system implements a method for determining an availability of an invitee, comprising:
creating, by a processor of a computing system, an artifact repository, the artifact repository including a plurality of artifacts;
analyzing, by the processor, the plurality of artifacts based on a plurality of parameters, and assigning a weighted value to each parameter of the plurality of parameters based on a business requirement, a user requirement, and a technical specification to determine a quantitative score of each artifact;
determining, by the processor, a qualitative score of each artifact of the plurality of artifacts by filtering the plurality of artifacts into one or more parameters, and calculating a total weighted value of each artifact of the plurality of artifacts, wherein the plurality of artifacts are separated into a plurality of data buckets based on user selected parameters;
clustering, by the processor, the plurality of artifacts from the plurality of data buckets during a search of the artifact repository using the qualitative value of each artifact to provide a closest match based on the user selected parameters;
retrieving, by the processor, a cluster containing the closest match and ranking the artifacts within the cluster based on the qualitative score of the artifacts within the cluster; and
providing, by the processor, the ranked artifacts to the user

16. The computer program product of claim 15, further comprising receiving, by the processor, user feedback to refine the ranked artifacts, wherein the user assigns extra points to an artifact to increase a rank of the artifact.

17. The computer program product of claim 15, wherein the plurality of parameters include generic criteria such as transaction name, version, inbound or outbound, kind of application, EDI standard, layout, customer, domain, section.

18. The computer program product of claim 15, wherein the plurality of artifacts are EDI documents.

19. The computer program product of claim 15, wherein clustering includes comparing an incoming artifact with the user-selected parameters.

20. The computer program product of claim 15, wherein clustering is a cognitive approach of unsupervised learning wherein a data cluster algorithm is used.
